(19) United States
(12) Patent Application Publication
(10) Pub. No.: US 2022/0351504 A1
(43) Pub. Date: Nov. 3, 2022

(54) METHOD AND APPARATUS FOR EVALUATING MATERIAL PROPERTY

(71) Applicant: HITACHI METALS, LTD., Tokyo (JP)

(72) Inventors: Takahiro Yoshioka, Tokyo (JP); Makoto Ono, Tokyo (JP); Hiroshi Moriya, Tokyo (JP); Tomohito Maki, Tokyo (JP); Takahiro Yomogita, Tokyo (JP)

(21) Appl. No.: 17/729,716

(22) Filed: Apr. 26, 2022

(30) Foreign Application Priority Data
Apr. 28, 2021 (JP) 2021-076672
Nov. 9, 2021 (JP) 2021-182754

(51) Int. Cl. G06V 10/82; G06V 30/194; G06K 9/62

(52) U.S. Cl. CPC G06V 10/82; G06V 30/194; G06K 9/6261

(57) ABSTRACT

A method for evaluating material properties includes an image processing for evaluation step, a material properties prediction step, and an evaluation step. The image processing for evaluation step includes scanning one or more images for evaluation of a material to be evaluated, creating a low-gradation image for evaluation by lowering gradation of the image for evaluation, and creating a virtual image by processing the low-gradation image for evaluation. The material properties prediction step includes extracting features for evaluation from the low-gradation image for evaluation, predicting a first material property of the material to be evaluated from the features for evaluation through a regression model, extracting a virtual-image feature from the virtual image, and predicting a second material property of the material to be evaluated from the virtual-image features through the regression model. The evaluation step is for comparing the first material property with the second material property.

### TECHNICAL FIELD

The present invention relates to a technique for evaluating properties of a material from images of the material.

### BACKGROUND

In recent years, a field of technology called materials informatics has been emerging in practical use. Materials informatics applies methodologies of data science to materials science, and the technology is expected to develop innovative materials as well as to speed up the time in material development.

Among data used for material development, images of a material photographed under electron microscopes or optical microscopes contain useful information related to material properties. It has been reported that, in some cases, photographed material images are analyzed making relations to material properties, aiming to improve the material properties.

As a method for making relations between material images and material properties, Japanese Unexamined Patent Application Publication No. 2018-133174 (JP-A-2018-133174) discloses a method for predicting material properties by using a neural network, for example. Also, Japanese Unexamined Patent Application Publication No. 2020-204824 (JP-A-2020-204824) discloses a method in which features are extracted from images to study relationships between material images and material properties, and area sizes for evaluation are determined.

Unfortunately, although it is possible for the method according to Japanese Unexamined Patent Application Publication No. 2018-133174 (JP-A-2018-133174), for example, to predict material properties from actual images of materials, it is difficult to reach a measure for improving the properties of the materials. Also, in the method according to Japanese Unexamined Patent Application Publication No. 2020-204824 (JP-A-2020-204824), it is necessary to actually produce the material, and measure and test its properties after considering relationships between the material images and material properties and setting up a hypothesis for obtaining the end properties. This takes a lot of labor and time at a stage where controlling technologies for material structures and compositions are not yet established.

### SUMMARY OF THE DISCLOSURE

In response to the above issues, it is an object of the present invention to provide a technology in which properties of a material that are estimated for property improvement can be tested easily and quickly without any measurements through experiments.

An aspect of the present invention is a method for evaluating material properties including an image processing for evaluation step, a material properties prediction step, and an evaluation step. The image processing for evaluation step is a step of scanning one or more images for evaluation of a material to be evaluated, creating a low-gradation image for evaluation by lowering gradation of the image for evaluation, and creating a virtual image by processing the low-gradation image for evaluation. The material properties prediction step is a step of extracting features for evaluation from the low-gradation image for evaluation, predicting a first material property of the material to be evaluated from the features for evaluation through a regression model, extracting virtual-image features from the virtual image, and predicting a second material property of the material to be evaluated from the virtual-image features through the regression model. The evaluation step is for comparing the first material property with the second material property.

Another aspect of the present invention is a method for evaluating material properties including a material properties primary prediction step, a virtual material properties prediction step, and a material search evaluation step. The material properties primary prediction step is a step of scanning one or more images for evaluation of a material to be evaluated, creating a low-gradation image for evaluation by lowering gradation of the image for evaluation, extracting features for evaluation from the low-gradation image for evaluation, and predicting a first material property of the material to be evaluated from the features for evaluation through a regression model. The virtual material properties prediction step is for creating a virtual image from the low-gradation image for evaluation by changing processing conditions to the low-gradation image for evaluation, extracting virtual-image features from the virtual image, predicting material properties for each of the processing conditions from the virtual-image features through the regression model, and determining a third material property among the material properties for each of the processing conditions. The material search evaluation step is for comparing the first material property with the third material property, and deciding that at least one of the first material property and the third material property is a fourth material property. The virtual material properties prediction step and the material search evaluation step are repeatedly carried out while replacing the fourth material property and an image used for computing the fourth material property with the first material property and the low-gradation image for evaluation, respectively.

Preferably, the method for evaluating material properties according to the present invention further includes an image processing for learning step and a machine learning step. The image processing for learning step is a step of creating low-gradation images for learning by lowering gradation of a plurality of images for learning obtained through photographing one or more materials for learning to have a group of low-gradation images for learning. The machine learning step is for loading and making correlations between the group of low-gradation images for learning and material properties of the materials for learning in the group of low-gradation images for learning, extracting features for learning from the low-gradation images for learning, and learning a regression model that predicts material properties of the materials for learning from the features for learning.

Also, it is preferable that the method for evaluating material properties according to the present invention further includes a feature specifying step of reducing features for learning that are required for predicting material properties from the low-gradation images for learning.

Another aspect of the present invention is an apparatus for evaluating material properties including an image processing for evaluation unit, a material properties prediction unit, and an evaluation unit. The image processing for evaluation unit is for scanning one or more images for evaluation of a material to be evaluated, creating a low-gradation image for evaluation by lowering gradation of the image for evaluation, and creating a virtual image by processing the low-gradation image for evaluation. The material properties prediction unit is for extracting features for evaluation from the low-gradation image for evaluation, predicting a first material property of the material to be evaluated from the features for evaluation through a regression model, extracting virtual-image features from the virtual image, and predicting a second material property of the material to be evaluated from the virtual-image features through the regression model. The evaluation unit is for comparing the first material property with the second material property.

Another aspect of the present invention is an apparatus for evaluating material properties including a material properties primary prediction unit, a virtual material properties prediction unit, and a material search evaluation unit. The material properties primary prediction unit is for scanning one or more images for evaluation of a material to be evaluated, creating a low-gradation image for evaluation by lowering gradation of the image for evaluation, creating a virtual image by processing the low-gradation image for evaluation, extracting features for evaluation from the low-gradation image for evaluation, and predicting a first material property of the material to be evaluated from the features for evaluation through a regression model. The virtual material properties prediction unit is for creating a virtual image from the low-gradation image for evaluation by adding various processing conditions to the low-gradation image for evaluation, extracting virtual-image features from the virtual image, predicting material properties for each of the processing conditions from the virtual-image features through the regression model, and determining a third material property among the material properties for each of the processing conditions. The material search evaluation unit is for comparing the first material property with the third material property, and deciding that at least one of the first material property and the third material property is a fourth material property. Processes by the virtual material properties prediction unit and processes by the material search evaluation unit are repeatedly carried out while replacing the fourth material property and an image used for computing the fourth material property with the first material property and the low-gradation image for evaluation, respectively.

The present invention can provide a technology in which properties of a material structure that are estimated for property improvement can be tested easily and quickly without any measurements through experiments.

### BRIEF DESCRIPTION OF DRAWINGS

FIG. 1 is an exemplary flowchart of a method for evaluating material properties according to a first embodiment of the present invention.

FIG. 2 is an exemplary flowchart illustrating a procedure of a material properties prediction step.

FIG. 3 is a flowchart of a method for evaluating material properties according to a second embodiment of the present invention.

FIG. 4 shows examples of a group of electron microscopic images of a magnet for learning photographed under an electron microscope and a group of low-gradation images for learning made by lowering gradation of the group of the electron microscopic images.

FIG. 5 is an example of a material list.

FIG. 6 is an exemplary flowchart showing a procedure of a machine learning step.

FIG. 7 is a flowchart showing a feature specifying step.

FIG. 8 is an exemplary flowchart showing a procedure for selecting features.

FIG. 9 shows examples of an electron microscopic image of a magnet for evaluation photographed under an electron microscope, a low-gradation image for evaluation made by lowering gradation of the electron microscopic image, and a virtual image for evaluation made by processing the low-gradation image for evaluation.

FIG. 10A shows examples of a material property (residual magnetic flux density) predicted from a low-gradation image for evaluation and a virtual image for evaluation.

FIG. 10B shows examples of a material property (coercive force) predicted from the low-gradation image for evaluation and the virtual image for evaluation.

FIG. 11A shows examples of residual magnetic flux density predicted from electron microscopic images.

FIG. 11B shows examples of residual magnetic flux density predicted from low-gradation images.

FIG. 12A shows examples of coercive force predicted from electron microscopic images.

FIG. 12B shows examples of coercive force predicted from low-gradation images.

FIG. 13 is a flowchart showing a third embodiment of the present invention.

FIG. 14 is a flowchart of a learning process in a fourth embodiment of the present invention.

FIG. 15A is a graph of predicted values of a magnetic property (residual magnetic flux density) for each rectangular region in the fourth embodiment of the present invention plotted against actual measurement values thereof.

FIG. 15B is a graph of predicted values of a magnetic property (residual magnetic flux density) for each sample in the fourth embodiment of the present invention plotted against actual measurement values thereof.

FIG. 15C is a graph of predicted values of a magnetic property (coercive force) for each rectangular region in the fourth embodiment of the present invention plotted against actual measurement values thereof.

FIG. 15D is a graph of predicted values of a magnetic property (coercive force) for each sample in the fourth embodiment present invention plotted against actual measurement values thereof.

FIG. 16 shows examples of images and BH of a material structure created in the fourth embodiment of the present invention.

FIG. 17A shows change in residual magnetic flux density against a loop count at the time of creating the images of FIG. 16.

FIG. 17B shows change in coercive force against the loop count at the time of creating the images of FIG. 16.

FIG. 17C shows change in BH against the loop count at the time of creating the images of FIG. 16.

FIG. 18 is a view showing a hardware configuration of a computer 30.

### DETAILED DESCRIPTION

Some embodiments of a method for evaluating material properties of the present invention will be described hereinafter. More specifically, examples in which electron microscopic images of a magnet (hereinafter, referred to as electron microscopic images) are used to examine property change in residual magnetic flux density and coercive force, which are important material properties of a magnet (hereinafter, referred to as material properties), will be described.

### First Embodiment

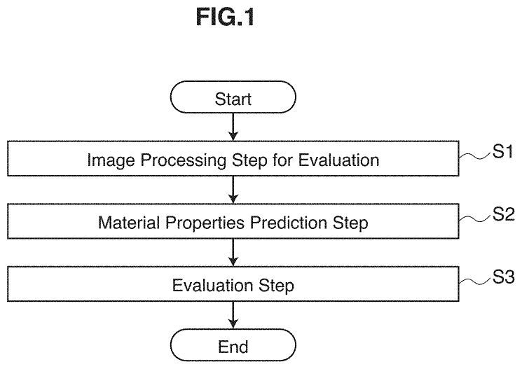

First, a first embodiment of the method for evaluating material properties will be described according to a flowchart shown in FIG. 1.

(Image Processing for Evaluation Step S1)

First, in an image processing for evaluation step S1, one or more images obtained by photographing a magnet for evaluation are scanned, and gradation of the scanned images are then lowered to create low-gradation images for evaluation. Next, the low-gradation images for evaluation are processed to create virtual images for evaluation.

(Material Properties Prediction Step S2)

A material properties prediction step S2 is for predicting a first material property (a magnetic property of the magnet for evaluation) from the low-gradation images for evaluation created in the image processing for evaluation step S1 and a second material property (a virtual magnetic property of the magnet for evaluation) from the virtual images for evaluation by using a learned regression model according to the present embodiment.

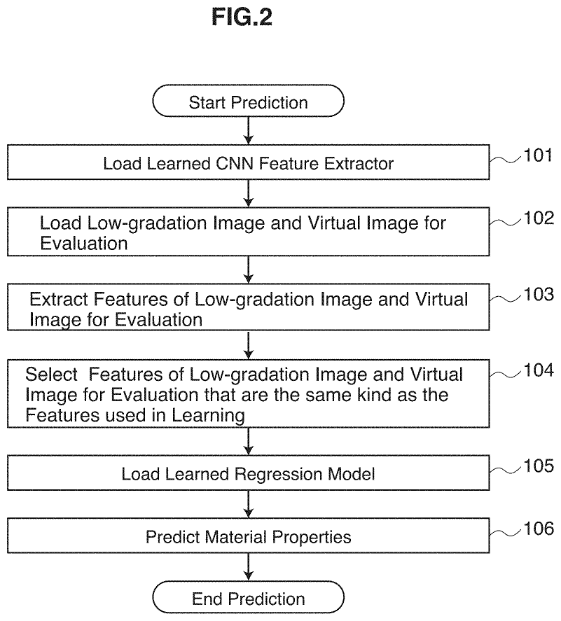

FIG. 2 is an exemplary flowchart illustrating a procedure of the material properties prediction step S2.

In a step 101, VGG16, which is a feature extractor of a learned convolutional neural network in the present embodiment, is loaded.

In a step 102, the low-gradation images for evaluation and the virtual image for evaluation created from the low-gradation images for evaluation are loaded.

In a step 103, features for evaluation and virtual-image features from each of the images are extracted by using the loaded feature extractor.

In a step 104, the features for evaluation and the virtual-image features out of the extracted features for evaluation and virtual-image features are selected. At this time, the features for evaluation and the virtual-image features need to be the same kind as features for learning used at the time of learning the regression model.

In a step 105, a learned regression model is loaded.

In a step 106, the loaded regression model is used to predict the magnetic property of the magnet for evaluation corresponding to the low-gradation images for evaluation, and the virtual magnetic property of the magnet for evaluation corresponding to the virtual images for evaluation, respectively.

(Evaluation Step S3)

In an evaluation step S3, the magnetic properties of the magnet for evaluation are evaluated using results predicted in the material properties prediction step S2.

To use a regression model of machine learning, it is necessary for the regression model to be learned at least once in advance. So, a process for extracting features and learning the regression model (a learning process) can be added before the method for evaluating material properties described as the first embodiment.

Here, the learning process includes an image processing for learning step and a machine learning step. The image processing for learning step is for creating low-gradation images for learning by lowering gradation of a plurality of images for learning obtained through photographing one or more materials for learning to have a group of low-gradation images for learning. The machine learning step is for loading and making correlations between the group of low-gradation images for learning and magnetic properties of the materials for learning in the group of low-gradation images for learning, extracting features for learning from the low-gradation images for learning, and learning a regression model that predicts magnetic properties of the materials for learning from the features for learning.

### Second Embodiment

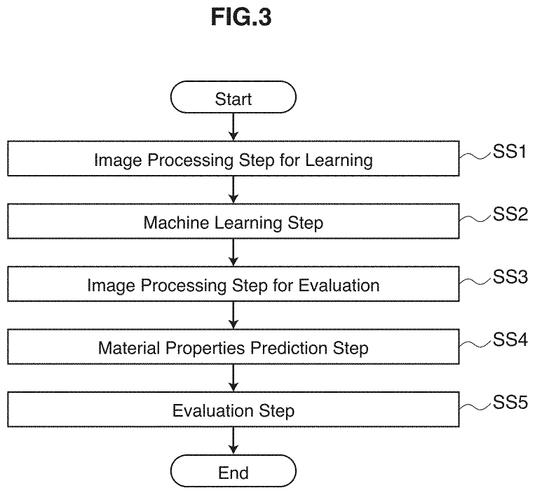

Next, as a second embodiment of the present embodiment, a method for evaluating material properties including the above-mentioned learning process will be described. FIG. 3 is a flowchart of the method for evaluating material properties according to the second embodiment of the present invention. The second embodiment will be described according to the flowchart shown in FIG. 3.

(Image Processing for Learning Step SS1)

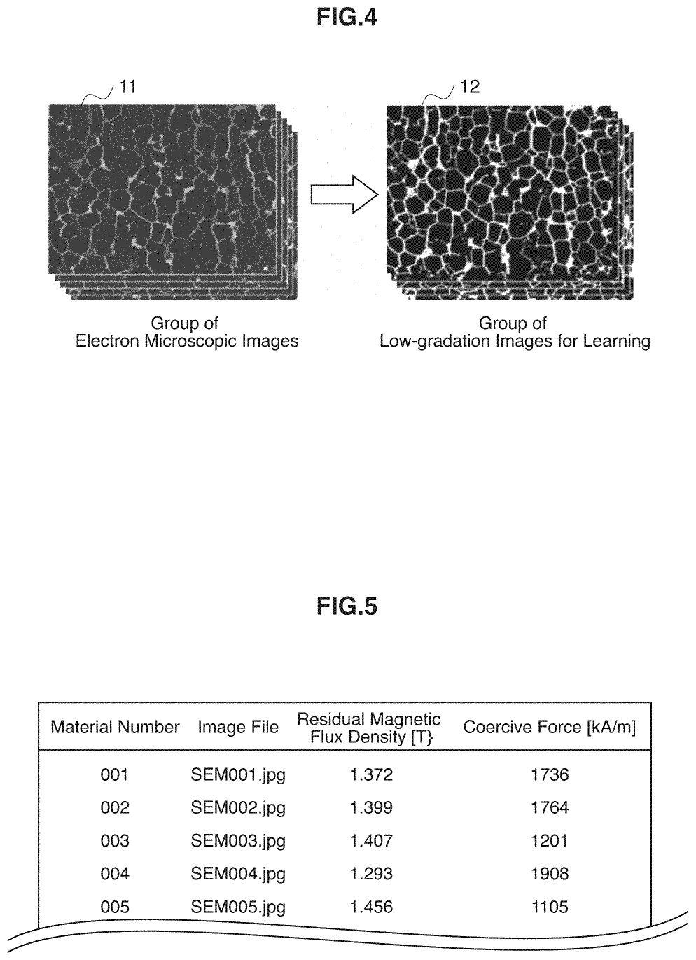

In an image processing for learning step SS1, a group of images including a plurality of images obtained through photographing a magnet for learning are loaded, and gradation of each of the images of the loaded group of images is lowered to create a low-gradation image for learning. FIG. 4 shows examples of a group of electron microscopic images 11 of the magnet for learning photographed under an electron microscope, and a group of low-gradation images for learning 12 created according to the present embodiment. The group of electron microscopic images 11 of the magnet for learning photographed under the electron microscope includes a plurality of cross-sectional structural images.

Here, low-gradation process is not limited to binarization and any other number of gradations may be used. For example, if three or more types of phases exist, different luminance may be allotted to each phase and the gradation may be processed with the number of the phases. Also, although the present embodiment uses a binarization processing according to thresholds of luminance for the low-gradation process, other image processing methods such as an edge detection or segmentation by deep learning may also be used to obtain desired low-gradation images.

(Machine Learning Step SS2)

Next, a machine learning step SS2 in the present embodiment is a step for loading and making correlations between the group of low-gradation images for learning including the plurality of low-gradation images for learning created in the image processing for learning step SS1 and magnetic properties of the material for learning in each of the low-gradation images for learning, extracting features for learning from the loaded low-gradation images for learning, and learning a regression model that predicts magnetic properties of the material for learning from the features for learning.

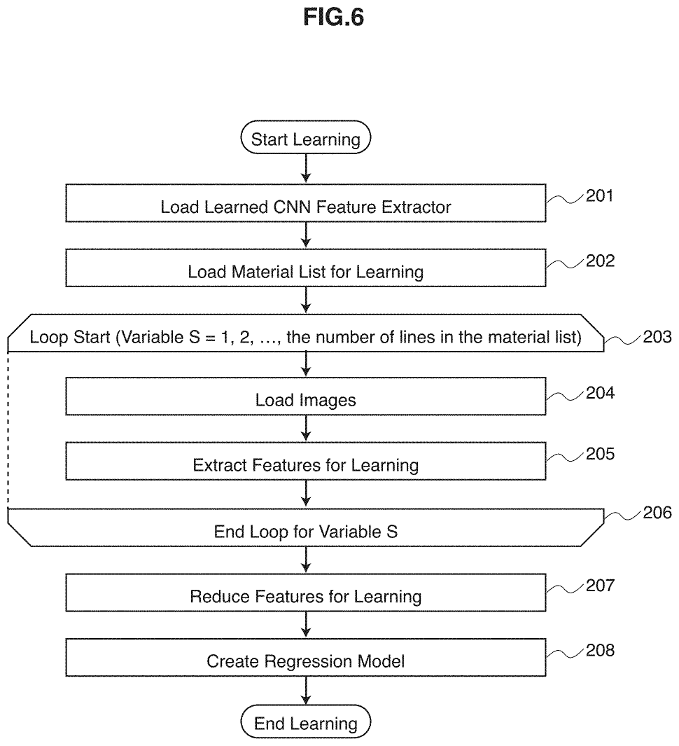

Here, as mentioned above, to make correlations between the photographed images of the material and the magnetic properties corresponding to the images, it is preferable to use a material list. FIG. 5 is an example of a material list in the present embodiment. The material list in FIG. 5 lists material numbers showing the magnets for learning, actual measurement values of residual magnetic flux density and coercive force measured as the magnetic properties, and names of image files of low-gradation images processed for low-gradation based on the photographed images of the magnet under the electron microscope.

Data for each material are listed horizontally. In the example, a measurement result of magnetic flux density, a measurement result of coercive force, and an image are managed for each material.

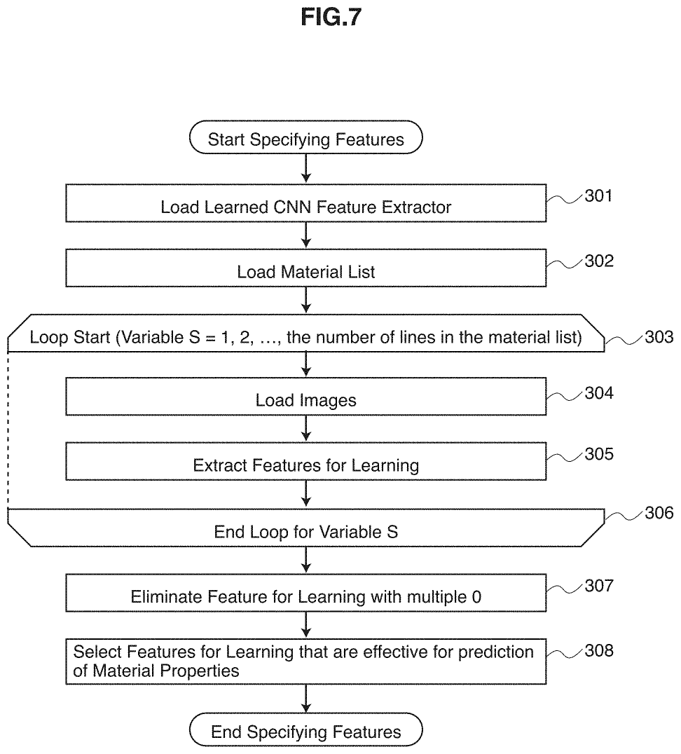

FIG. 6 is an exemplary flowchart showing a procedure of the machine learning step SS2 for learning the regression model in the present embodiment.

In a step 201, VGG16, which is a feature extractor of a learned convolutional neural network (CNN) that is open to public on the Internet, is loaded, for example.

The feature extractor is learned for classification of animals, plants, and other objects, and not for analyzing material images of magnets, ceramics, or metals, which are subjects of the present invention. Python, which is a language often used in a field of machine learning, can load VGG16 by using a function “keras.application” that is incorporated within a deep learning library “Keras”, for example.

Although VGG16 is loaded as the feature extractor in the present embodiment, others such as VGG19 or Xception may also be used.

In a step 202, a material list for learning, as shown in FIG. 5 (hereinafter, refereed to as a material list for learning), is loaded.

Steps 203 to 206 form a loop repeated for the number of lines in the material list for learning, i.e., for the number of the images.

In a step 204, image files listed on the material list for learning are loaded.

In a step 205, features for learning are extracted from the images by using the feature extractor of the learned convolutional neural network loaded in the step 201.

In a step 207, unnecessary features are eliminated among the several tens of thousands of features for learning extracted in the step 205. Conceivable examples of criteria for elimination as the unnecessary features are: whether the feature includes effective numerical values other than zero above a certain amount or not, and whether the feature contributes to the prediction or not.

As above, the features for learning are extracted from the loaded low-gradation images for learning.

In a step 208, any of regression machine learning methods such as a multiple regression analysis, random forest, or support vector machines may be applied.

Such the machine learning methods have advantages of capable of learning with the fewer number of materials than neural networks.

The present embodiment uses random forest as the regression model.

As above, in the machine learning step SS2, the images are input, and the regression model that predicts the magnetic properties, i.e., residual magnetic flux density and coercive force herein, via the convolutional neural network by using random forest is created.

To create a regression model having further higher prediction accuracy, it is effective in many cases to eliminate further the features for learning. So, as a preparation for learning before performing the machine learning step SS2, it is possible to add a process for reducing the features for learning required to predict the magnetic properties (a feature specifying step).

Here, if the feature specifying step is added before the machine learning step SS2, the other features for learning than the features for learning specified in the feature specifying step are eliminated as unnecessary values in the step 207 in the machine learning step SS2.

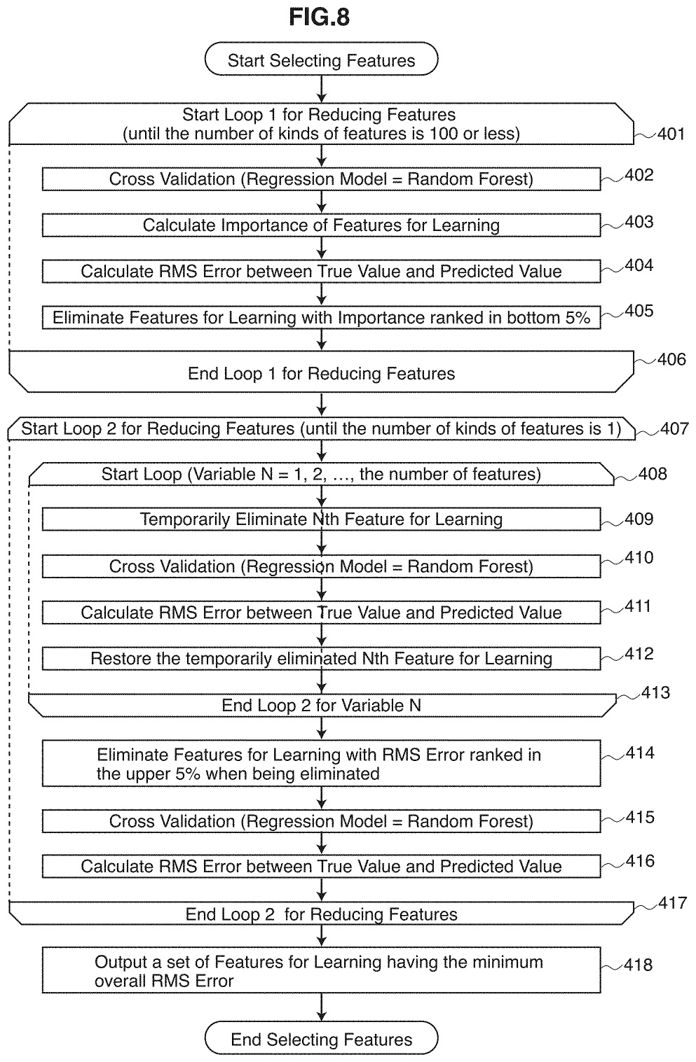

FIG. 7 is an example of a flowchart showing a learning preparation process in the feature specifying step, which is to be added before the machine learning step for learning the regression model in the present embodiment.

In a step 301, VGG16, which is a feature extractor of a learned convolutional neural network, is loaded.

In a step 302, a material list for learning as shown in FIG. 5 is loaded.

Step 303 to 306 form a loop repeated for the number of lines in the material list for learning, i.e., for the number of the images. In a step 304, an image file listed on the material list is loaded.

In a step 305, features for learning are extracted from the images by using the feature extractor of the learned convolutional neural network loaded in the step 301.

There are many cases in which only zero value is entered as the feature. Thus, in a step 307, the feature for learning in which values zero are entered into 90% or more of the entire feature is eliminated, for example.

In a step 308, the features for learning that are effective for predicting the magnetic properties are extracted from the features for learning, thereby further reducing the features for learning. For example, for an image size of 320 pixels by 240 pixels, approximately 10,000 kinds of features for learning are likely to remain for each of the images even after reducing the features for learning in the step 307. So, in the step 308, the features for learning are selected and reduced by using importance of the feature for learning calculated when learned in random forest, for example, or a coefficient of determination or a root-mean-square (RMS) error at the time of prediction as an index for elimination of the features for learning.

In an example of the present embodiment in which residual magnetic flux density and coercive force are to be predicted, the features for learning are eventually reduced to approximately 10 to 20 kinds.

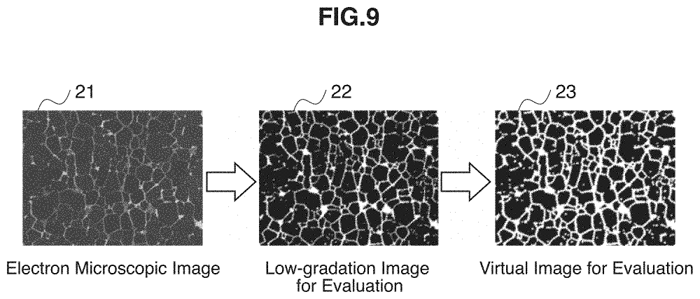

FIG. 8 is an exemplary flowchart showing a procedure for selecting the features for learning that are effective in prediction of the magnetic properties in the step 308.

Here, as an index for selecting the features for learning, the present embodiment uses the importance of the features for learning calculated when learned in random forest.

From a step 401 to a step 406, the features for learning are reduced in stages using the importance of the features for learning as the index until the number of kinds of the features for learning is 100.

In a step 402, a cross-validation is performed using random forest as the regression model.

In a step 403, the importance of each of the features for learning is calculated.

In a step 404, the RMS error is calculated from a true value (an actual measurement value) of the magnetic property and the predicted value calculated from the cross-validation.

In a step 405, the features for learning having the importance that is ranked in the bottom 5% are eliminated.

From a step 407 to a step 417, the features for learning are reduced in stages using the true value of the magnetic property and the RMS error of the predicted value at the time of the cross-validation as the index until the number of kinds of the features for learning is 1.

Steps 408 to 413 form a loop repeated for the number of the features for learning, and an effect to each of the predicted values of the features for learning are examined.

In a step 409, a set of the features for learning in which one kind of the features for learning is temporarily eliminated is created.

In a step 410, the cross-validation is performed using random forest as the regression model.

In a step 411, the RMS error is calculated from the true value of the magnetic property and the predicted value calculated from the cross-validation.

In a step 412, the temporarily eliminated features for learning are restored.

In a step 414, the feature for learning with an absolute value of the RMS value being ranked within the smaller 5% when being eliminated is eliminated. That is, the feature for learning having negative effects with regard to prediction accuracy is eliminated.

In a step 415, the cross-validation is performed using random forest as the regression model.

In a step 416, the RMS value is calculated from the true value of the magnetic property and the predicted value calculated from the cross-validation.

In a step 418, a set of the features for learning having the minimum RMS value calculated from the true value of the magnetic property and the predicted value calculated from the cross-validation is output.

(Image Processing for Evaluation Step SS3)

In an image processing for evaluation step SS3, the same processes as the image processing for evaluation step S1 described in the method for evaluating material properties according to the first embodiment is performed. That is, in the image processing for evaluation step SS3, one or more images obtained by photographing the magnet for evaluation are scanned, and gradation of the scanned images are then lowered to create low-gradation images for evaluation. Next, the low-gradation images for evaluation are processed to create virtual images for evaluation.

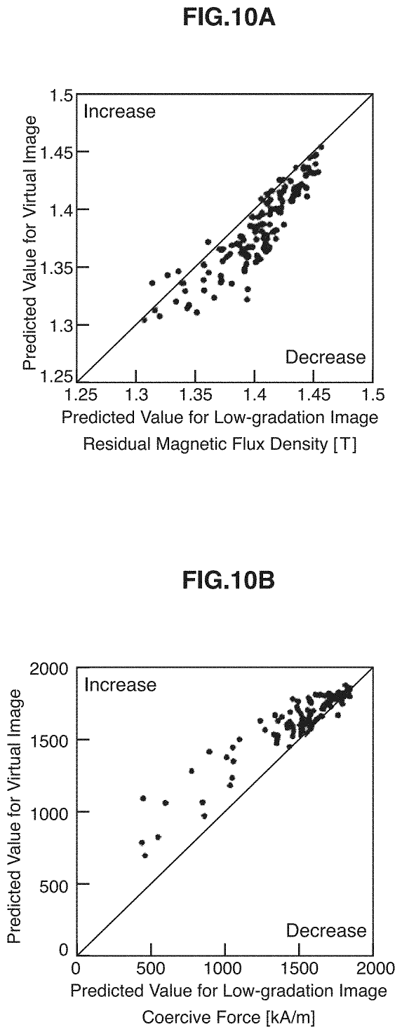

FIG. 9 shows examples of an electron microscopic image 21 of the magnet for evaluation photographed under an electron microscope, and a low-gradation image for evaluation 22 and a virtual image for evaluation 23 that are created according to the present embodiment.

Here, the low-gradation process is not limited to binarization, and any other number of gradations may be used. For example, if three or more types of phases exist, different luminance may be allotted to each phase and gradation may be processed with the number of the phases. Also, although the present embodiment uses a binarization processing according to thresholds of luminance for the low-gradation process, other image processing methods such as an edge detection or segmentation by deep learning may also be used to obtain desired low-gradation images.

The virtual image for evaluation 23 is an exemplary virtual image of the magnet for evaluation, in which pixels corresponding to white colored parts of the low-gradation image for evaluation 22, which is created by binarization of white and black colors, are processed for expansion so as to expand the white colored parts.

By evaluating the virtual image for evaluation 23 by regarding the virtual image for evaluation 23 as a photographed image of a virtual magnet having a phase corresponding to the white colored parts of the low-gradation image for evaluation 22 being expanded, it is possible to examine how the magnetic properties of the magnet with the expanded white colored parts change. The processing at the time of creating the virtual image for evaluation 23 is not limited to the expansion processing, and a contraction processing may also be performed. Furthermore, only a part of the image may be processed.

(Material Properties Prediction Step SS4)

A material properties prediction step SS4 performs the same processes as the material properties prediction step S2 described in the method for evaluating material properties according to the first embodiment. That is, in the material properties prediction step SS4, the first material property (a magnetic property of the magnet for evaluation) from the low-gradation images for evaluation created in the image processing for evaluation step SS3 and the second material property (a virtual magnetic property of the magnet for evaluation) from the virtual images for evaluation are predicted by using the learned regression model according to the present embodiment. The material properties prediction step SS4, which is the same as the above-mentioned material properties prediction step S2, will be described using the flowchart shown in FIG. 2 that shows the procedure of the material properties prediction step S2.

In the step 101, VGG16, which is a feature extractor of a learned convolutional neural network in the present embodiment, is loaded.

In the step 102, the low-gradation images for evaluation and the virtual image for evaluation created from the low-gradation images for evaluation are loaded.

In the step 103, features for evaluation and virtual-image features are extracted from each of the images by using the loaded feature extractor.

In the step 104, the features for evaluation and the virtual-image features that are the same kind as features for learning used at the time of learning the regression model in the step 208 of the machine learning step SS2 are selected from the extracted features for evaluation and virtual-image features.

In the step 105, the learned regression model learned in the step 208 of the machine learning step SS2 is loaded.

In the step 106, the loaded regression model is used to predict the magnetic property of the magnet for evaluation corresponding to the low-gradation images for evaluation, and the virtual magnetic property of the magnet for evaluation corresponding to the virtual images for evaluation, respectively.

(Evaluation Step SS5)

In an evaluation step SS5, the same processes as the evaluation step S3 described in the method for evaluating material properties according to the first embodiment is performed. That is, in the evaluation step SS5, the magnetic properties of the magnet for evaluation are evaluated using results predicted in the material properties prediction step SS4.

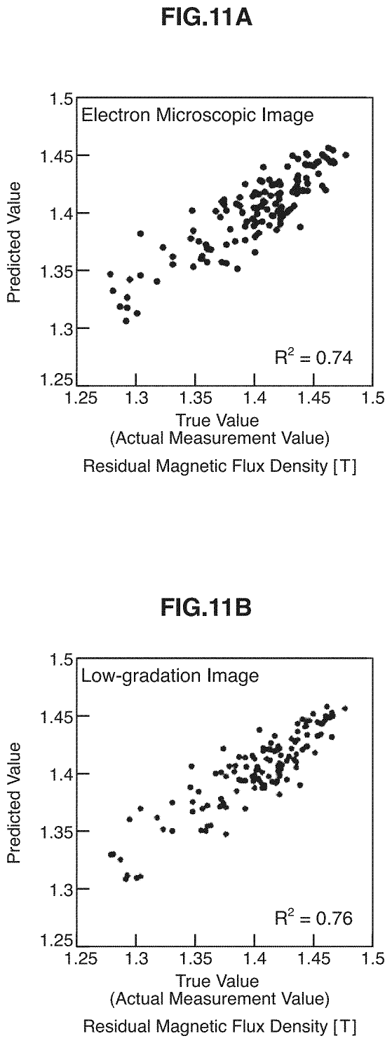

FIGS. 10A to 10C are graphs comparing residual magnetic flux density and coercive force predicted from the virtual images for evaluation of the present embodiment and the low-gradation images for evaluation that are bases for the virtual image for evaluation. Dots shown in the graphs are predicted values of residual magnetic flux density and coercive force of 128 magnets for evaluation, respectively. From FIGS. 10A to 10C, when imagining a magnet having an expanded phase corresponding to the white colored pars of the low-gradation image for evaluation as in the present embodiment, it is confirmed that there is an overall tendency that the residual magnetic flux density decreases and the coercive force increases. That is, with such the evaluation, it is possible to examine the changes in the magnetic properties that occur when changing the low-gradation images for evaluation to the virtual images for evaluation.

To evaluate the change in the magnetic properties, the present embodiment uses a method for observing an overall tendency by predicting the magnetic properties of the multiple numbers of the low-gradation images for evaluation and of the corresponding virtual images for evaluation. However, there are other unlimited methods such as calculating a difference between each of the predicted magnetic properties.

In the present embodiment described as above, the virtual images for evaluation are created from the low-gradation images for evaluation and the magnetic properties corresponding to such the images are predicted. Thus, structures of the magnet for achieving the desired magnetic properties can be examined without actually fabricating a product.

Next, values of residual magnetic flux density and coercive force predicted by using the unprocessed electron microscopic images of the magnet are compared with values of residual magnetic flux density and coercive force predicted by using low-gradation images of the electron microscopic images of the magnet.

The values of residual magnetic flux density and coercive force predicted from the electron microscopic images and the low-gradation images are calculated by using each of a group of the electron microscopic images and a group of the low-gradation images in a flow of the feature specifying step shown in FIG. 7. More specifically, cross-validation using random forest is performed to each of the group of the electron microscopic images and the group of the low-gradation images, and, while calculating the predicted values of residual magnetic flux density and coercive force, the RMS value error with the true values (actual measurement values of residual magnetic flux density and coercive force) are calculated so as to select the features. The predicted values, at which the RMS error value is the smallest, are to be used as the predicted values of residual magnetic flux density and coercive force.

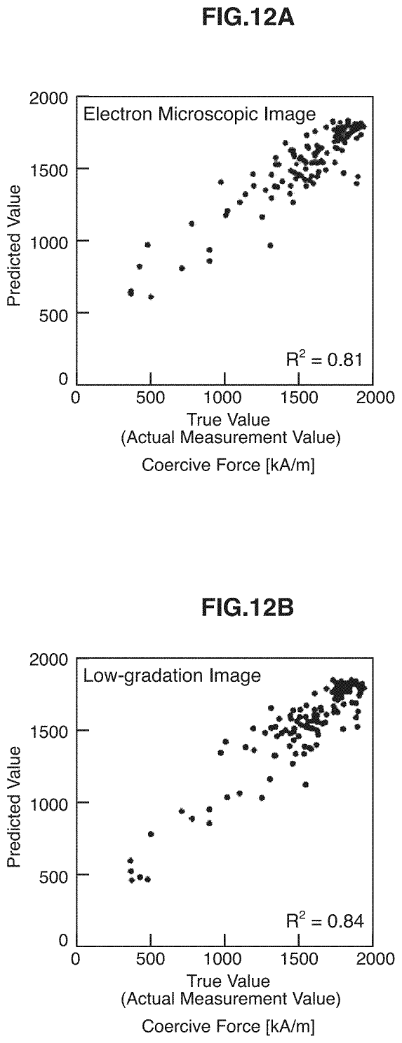

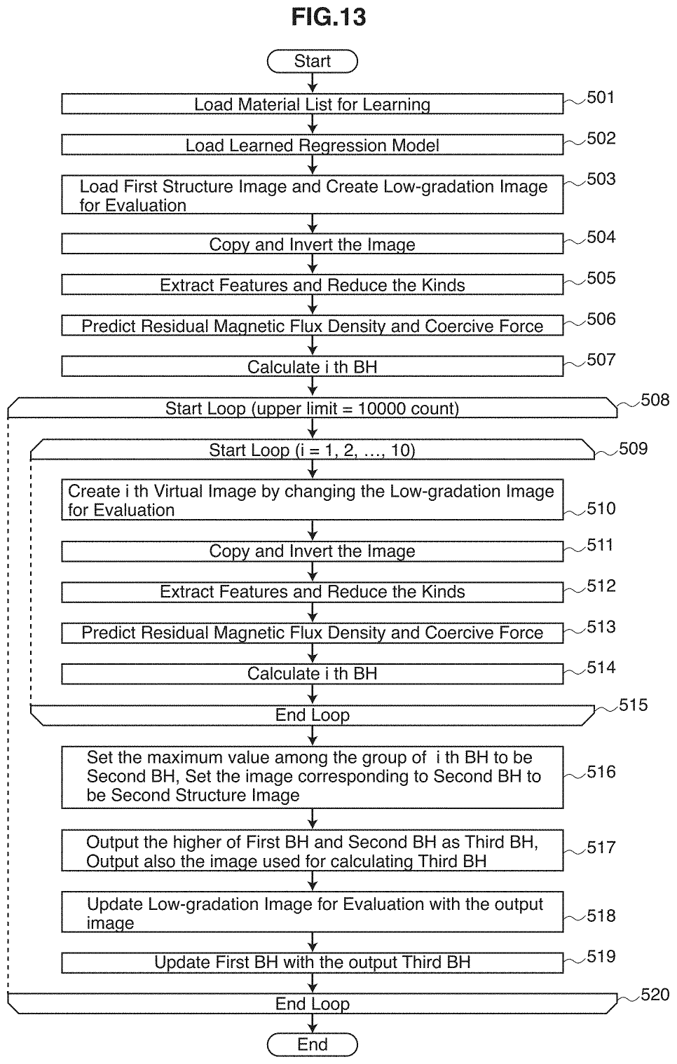

FIG. 11s and FIGS. 12A and 12B are predicted values of residual magnetic flux density and coercive force of each material of the group of the electron microscopic images or the group of the low-gradation images plotted against the 128 true values of residual magnetic flux density and coercive force (actual measurement values of residual magnetic flux density and coercive force).

Coefficients of determination (R² value), which are used in a study of statistics, of the residual magnetic flux density predicted by using the group of the electron microscopic images and the residual magnetic flux density predicted from the low-gradation images are calculated to be 0.74 and 0.76, respectively. Also, coefficients of determination (R² value) of the coercive force predicted from the group of the electron microscopic images and the coercive force predicted from the low-gradation images are similarly calculated to be 0.81 and 084, respectively.

The results show that the magnetic properties can be predicted by using the low-gradation images of the electron microscopic images of the magnet with almost the same coefficient of determination as in a case where the unprocessed electron microscopic images of the magnet are used.

### Third Embodiment

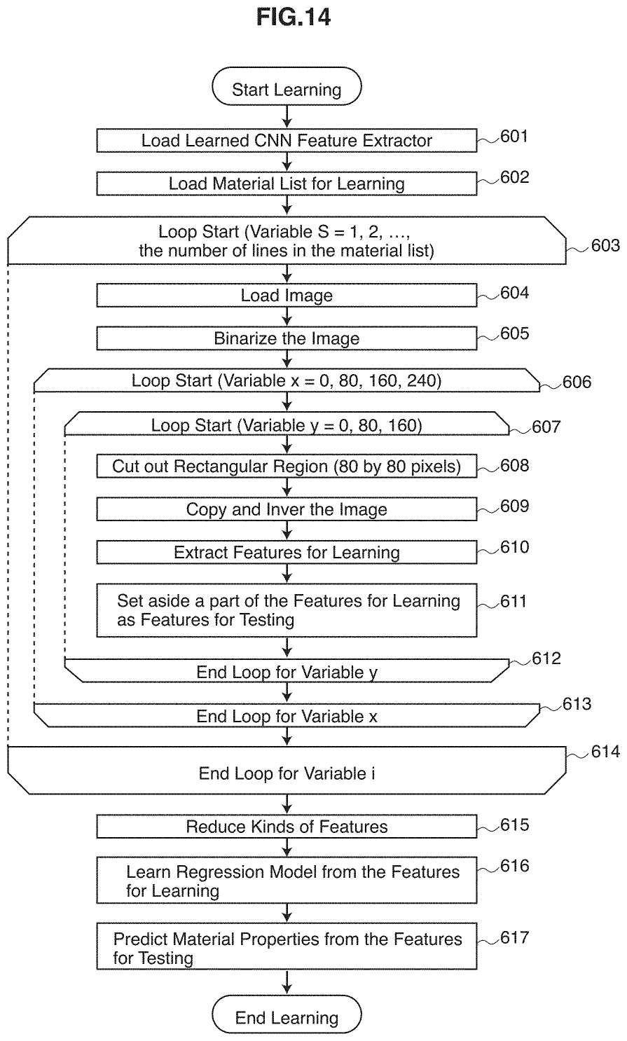

FIG. 13 shows a flowchart according to a third embodiment for creating material structure images from the electron microscopic images for improvement of the magnetic properties. More specifically, the flowchart is for creating the material structure images that can improve a multiplied value (BH) of normalized residual magnetic flux density and coercive force from a first material structure image.

In a step 501, the material list for learning is loaded.

In a step 502, the learned regression model is loaded.

In a step 503, a material structure image is loaded as a first structure image. The first structure image, which is a starting image, needs to have the same size as an image used at the time of learning the regression model. In the present embodiment, an image having 80 by 80 pixels cut out from a binarized electron microscopic image is used as the first structure image. The loaded image is then processed for low-gradation and a low-gradation image for evaluation is created.

In a step 504, the low-gradation image for evaluation is copied and inverted, and the image is expanded into four images. The step 504 may be omitted although the step 504 is effective for improving prediction accuracy,

In a step 505, features from the low-gradation image for evaluation are extracted. The extracted features that are the same kinds as the features for learning input into the regression model are kept, and the others are eliminated.

In a step 506, residual magnetic flux density and coercive force of the low-gradation image for evaluation are predicted by using the learned regression model. The predicted values of residual magnetic flux density and coercive force are average values predicted from the four data-expanded images.

In a step 507, the predicted residual magnetic flux density and coercive force are normalized using a formula in which actual measurement values in the material list for learning are normalized. The normalized residual magnetic flux density multiplied by the normalized coercive force is to be the first material property (hereinafter, referred to as the first BH).

Here, steps 503 to 507 are a material properties primary prediction step, which is a step for scanning one or more images for evaluation of the material to be evaluated, creating the low-gradation image for evaluation by lowering gradation of the image for evaluation, extracting the features for evaluation from the low-gradation image for evaluation, and predicting the first material property from the features for evaluation by the regression model.

Steps 508 to 520 can be repeated for any number of times. In the present embodiment, the repetition terminates after either 10,000 times of repetition or 200 continuous no improvements of BH, whichever is earlier.

Steps 509 to 515 are repeated with a variable i for any number of times. The number of times for repetition is the number of candidates compared in one loop between the step 508 and the step 520. The repetition may also be omitted. The present embodiment repeats the steps for 10 times.

In a step 510, an i-th virtual image is created by processing the low-gradation image with randomly varied processing conditions according to some rules. In the present embodiment, a pixel is selected randomly, and blacks and whites are inverted.

A method for varying the process conditions is not limited to the above, and other methods, in which a pixel on a white/black border is to be varied, only a change from white to black is allowed, or only a change from black to white is allowed, are conceivable.

In a step 511, the i-th virtual image is copied and inverted, and the image is expanded into four images. The step 511 may be omitted although the step 511 is effective for improving prediction accuracy,

In a step 512, features are extracted from the i-th virtual image. The extracted features that are the same kinds as the features for learning input into the regression model are kept, and the others are eliminated.

In a step 513, residual magnetic flux density and coercive force of the i-th virtual image are predicted by using the learned regression model similarly as the step 506.

In a step 514, BH is calculated similarly as the step 507. This BH (hereinafter, referred to as i-th BH) becomes the material property for each of the processing conditions.

In a step 516, the maximum value among a group of the ten i-th BH calculated within a loop from the step 509 to the step 515 is taken as a third material property (hereinafter, referred to as a second BH). Also, the i-th virtual image corresponding to the second BH is taken as a second structure image.

The steps 508 to 516 form a virtual material properties prediction step, which is a step for creating the virtual image from the low-gradation image for evaluation by changing the various processing conditions to the low-gradation image for evaluation, predicting material properties for each of the processing conditions of the virtual image for each of the processing conditions, and determining the third material property among the material properties for each of the processing conditions.

In a step 517, the first BH is compared with the second BH, and the BH having higher property is output as a fourth material property (hereinafter, referred to as a third BH). In the step 517, the image (either the low-gradation image for evaluation or the second structure image) used for calculating the output third BH is also output. The step 517 is a material search evaluation step, which is for comparing the first material property with the third material property, and deciding that at least one of the first material property or the third material property is the fourth material property.

In a step 518, the low-gradation image for evaluation is updated with the image that has been output in the step 517.

In a step 519, the first BH is updated with the third BH that has been output in the step 517.

Then, the flow returns to the step 508 and repeats the steps 508 to 520 for any number of times. In the present embodiment, the repetition terminates after either 10,000 times of repetition or 200 continuous no improvements of BH, whichever is earlier.

Here, to use the regression model, it is necessary for the regression model to be learned at least once in advance. So, a process for extracting features and learning the regression model (a learning process) can be added before the method for evaluating material properties described in the third embodiment.

The learning process includes an image processing for learning step and a machine learning step. The image processing for learning step is for creating low-gradation images for learning by lowering gradation of a plurality of images for learning obtained through photographing one or more materials for learning to have a group of low-gradation images for learning. The machine learning step is for loading and making correlations between the group of low-gradation images for learning and magnetic properties of the materials for learning in the group of low-gradation images for learning, extracting features for learning from the low-gradation images for learning, and learning a regression model that predicts magnetic properties of the materials for learning from the features for learning.

### Fourth Embodiment

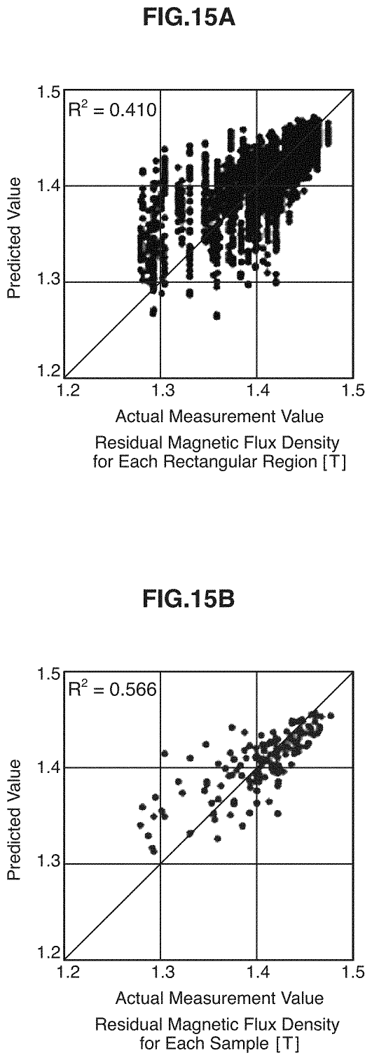

Next, as a fourth embodiment of the present embodiment, a method for evaluating material properties including the above-mentioned learning process will be described. FIG. 14 is a flowchart of the learning process of the method for evaluating material properties according to the fourth embodiment of the present invention. In the present embodiment, the material properties are evaluated using the learned regression model learned in accordance with a flow shown in FIG. 14, while the method for evaluating material properties is carried out in the same procedure as in FIG. 13. The fourth embodiment will be described in accordance with FIG. 14 and FIG. 13.

Next, the above-mentioned learning process will be described. FIG. 14 is a flowchart of the learning process of the present invention. The fourth embodiment will be described in accordance with FIG. 14 and FIG. 13.

FIG. 14 is an example of a flowchart showing a procedure of learning for learning the regression model according to the present embodiment.

In a step 601, VGG16, which is a feature extractor of a learned convolutional neural network (CNN) that is open to public on the Internet, is loaded.

The feature extractor is learned for classification of animals, plants, and other objects, and not for analyzing material images of magnets, ceramics, or metals, which are subjects of the present invention. Python, which is a language often used in a field of machine learning, can load VGG16 by using a function “keras.application” that is incorporated within a deep learning library “Keras”, for example.

Although VGG16 is loaded as the feature extractor in the present embodiment, others such as VGG19 or Xception may also be used.

In a step 602, a material list for learning as shown in FIG. 5 is loaded. The material list lists material numbers showing the magnets for learning, actual measurement values of residual magnetic flux density and coercive force measured as the magnetic properties, and names of image files. The actual measurement values of residual magnetic flux density and coercive force are normalized so that the maximum value is 1 and the minimum value is 0.

Steps 603 to 614 form a loop repeated for the number of lines in the material list for learning, i.e., for the number of the images.

In a step 604, an image file listed on the material list for learning is loaded as the image for learning. The present embodiment uses an image having 320 by 240 pixels.

In a step 605, low-gradation images for learning are created by lowering gradation of the image for learning. The present embodiment uses a binarization method as the low-gradation process. As the method for binarization of images, any image processing methods other than a binarizing method at a threshold, such as discriminant analysis or adaptive thresholding, may also be used. In the present embodiment, images are binarized into black and white at a certain threshold.

Steps 606 to 613 form a loop repeated for four types of variant x, where x is an x-coordinate of the image and varied as 0, 80, 160, and 240.

Steps 607 to 612 form a loop repeated for three types of variant y, where y is a y-coordinate of the image and varied as 0, 80, and 160.

In a step 608, an image of a rectangular region that is in a range of x to x+80 of the x-coordinate and y to y+80 of the y-coordinate is cut out, with the variants x and y as the starting coordinates of the rectangular region to be cut out.

In a step 609, the cutout image is copied and an image inverted at the x-axis, an image inverted at the y-axis, and an image inverted at the x-axis and further inverted at the y-axis are created. Such the process multiplies the one cutout image into four images. That is, an amount of data for learning can be artificially increased.

Although the step 609 is useful in improvement of prediction accuracy, the step 609 may be omitted if there is a sufficient amount of data.

In a step 610, the features for learning are extracted from the low-gradation images for learning using the feature extractor of the learned convolutional neural network loaded in the step 601.

In a step 611, a part of the extracted features for learning is set aside as features for testing, which are to be used in a predicted properties test in a step 617. The features set aside as the features for testing are removed from the features for learning.

In the present embodiment, twelve images each having 80 by 80 pixels are cut out from one image having 320 by 240 pixels, and the features extracted from four of the twelve images are taken as the features for testing.

In a step 615, unnecessary features are eliminated from 2048 kinds of the features for learning extracted in the step 610. Conceivable examples of criteria for elimination as the unnecessary features for learning are: whether the feature includes effective numerical values other than zero above a certain amount or not, and whether the feature contributes to the prediction or not.

In the present embodiment, the features for learning in which values zero are entered into 90% or more of the entire feature are eliminated.

As above, the features for learning are extracted from the loaded images for learning.

In a step 616, the regression model is learned using the features for learning as an explanatory variable and residual magnetic flux density and coercive force as a target variable. Any regression machine learning methods such as a multiple regression analysis, random forest, support vector machines, or neural networks may be applied.

The present embodiment uses a neural network as the regression model.

In the step 617, the features for testing are input into the learned regression model and the magnetic properties are predicted. The predicted magnetic properties are compared with the actual measurement values so as to evaluate performance of the regression model. In the present embodiment, coefficients of determination R² value, which are used in a study of statistics, are calculated from the predicted values and the actual measurement values.

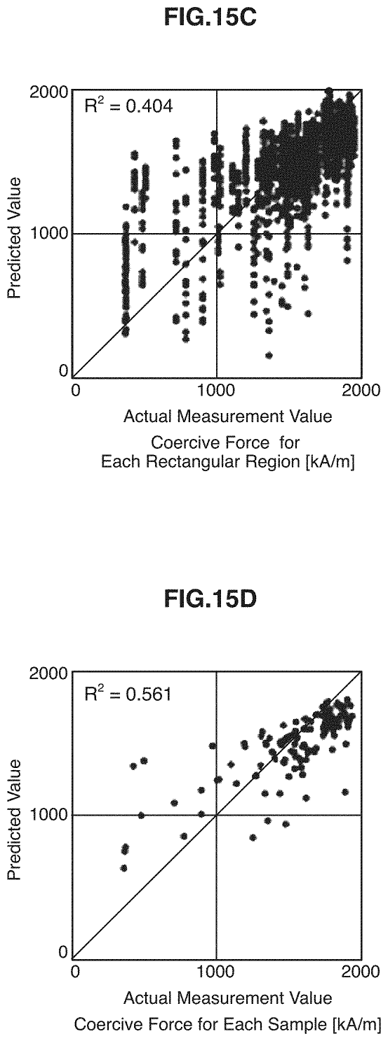

FIG. 15A and FIG. 15B are graphs of predicted values of magnetic properties for each rectangular region and each sample in the present embodiment plotted against actual measurement values thereof, respectively. The coefficient of determination R² of the predicted value and actual measurement value of residual magnetic flux density for each rectangular region is 0.41, and coefficient of determination R² of the predicted value and actual measurement value of residual magnetic flux density averaged for each sample is 0.57. The coefficient of determination R² of the predicted value and actual measurement value of coercive force for each rectangular region is 0.40, and coefficient of determination R² of the predicted value and actual measurement value of coercive force averaged for each sample is 0.56.

As above, in the steps 601 to 617, the images are input and the regression model that predicts the magnetic properties, i.e., residual magnetic flux density and coercive force herein, by using the neural network via the convolutional neural network, is created.

Next, a method for evaluating material properties using the regression model learned in the step 616 will be described. The present method for evaluating material properties is the same as the above-mentioned third embodiment, and will be described by using the flowchart according to the third embodiment shown in FIG. 13.

In the step 501, the material list for learning loaded in the step 602 is loaded.

In the step 502, the learned regression mode learned in the step 616 is loaded.

In the step 503, a material structure image as the first structure image is loaded. The first structure image, which is a starting image, needs to have the same size as an image used at the time of learning the regression model. In the present embodiment, an image having 80 by 80 pixels cut out from a binarized electron microscopic image is used as the first structure image. The loaded image is then processed for low-gradation and a low-gradation image for evaluation is created.

In the step 504, the low-gradation image for evaluation is copied and inverted, and the image is expanded into four images by the same way as in the step 609. The step 504 may be omitted although the step 504 is effective for improving prediction accuracy,

In the step 505, features are extracted from the low-gradation image for evaluation by the same way as in the step 610. The extracted features that are the same kinds as the features for learning input into the regression model are kept, and the others are eliminated.

In the step 506, residual magnetic flux density and coercive force of the low-gradation image for evaluation are predicted by using the regression model learned in the step 616. The predicted values of residual magnetic flux density and coercive force are average values of the predicted value from the four data-expanded images.

In the step 507, the predicted residual magnetic flux density and coercive force are normalized using a formula in which measurement values in the material list for learning are normalized in the step 602. The normalized residual magnetic flux density multiplied by the normalized coercive force is to be the BH.

Here, the steps from 503 to 507 form the material properties primary prediction step, which is a step for scanning one or more images for evaluation of the material to be evaluated, creating the low-gradation image for evaluation by lowering gradation of the image for evaluation, extracting the features for evaluation from the low-gradation image for evaluation, and predicting the first material property to the low-gradation image for evaluation from the features for evaluation by the regression model.

The steps from 508 to 520 can be repeated for any number of times. In the present embodiment, the repetition terminates after either 10,000 times of repetition or 200 continuous no improvements of BH, whichever is earlier.

The steps 509 to 515 are repeated with a variable i for any number of times. The number of times for repetition is the number of candidates compared in one loop between the step 508 and the step 520. The repetition may also be omitted. The present embodiment repeats the steps for 10 times.

In the step 510, an i-th virtual image by processing the low-gradation image with randomly varied processing conditions according to some rules is created. In the present embodiment, a pixel is selected randomly, and blacks and whites are inverted.

The method for varying the process conditions is not limited to the above, and other methods, in which a pixel on a white/black border is to be varied, only a change from white to black is allowed, or only a change from black to white is allowed, are conceivable.

In the step 511, the i-th virtual image is copied and inverted and the image is expanded into four images by the same way as in the step 609. The step 511 may be omitted although the step 511 is effective for improving prediction accuracy,

In the step 512, features are extracted from the i-th virtual image by the same way as in the step 610. The extracted features that are the same kinds as the features for learning are input into the regression model, and the others are eliminated.

In the step 513, residual magnetic flux density and coercive force of the i-th virtual image are predicted by using the learned regression model similarly as the step 506.

In the step 514, BH is calculated similarly as the step 507. This BH (hereinafter, referred to as i-th BH) becomes the material property for each of the processing conditions.

In the step 516, the maximum value among the ten i-th BHs calculated within a loop from the step 509 to the step 515 is taken as a third material property (hereinafter, referred to as a second BH). Also, the image corresponding to the second BH is taken as a second structure image.

The steps 508 to 516 form the virtual material properties prediction step, which is a step for creating the virtual image from the low-gradation image for evaluation by changing the various processing conditions to the low-gradation image for evaluation, predicting material properties for each of the processing conditions of the virtual image for each of the processing conditions, and determining the third material property among the material properties for each of the processing conditions.

In the step 517, the first BH is compared with the second BH, and the BH having higher property is output as a fourth material property (hereinafter, referred to as a third BH). The image (either the low-gradation image for evaluation or the second structure image) used for calculating the output third BH is also output. The step 517 is the material search evaluation step, which is for comparing the first material property with the third material property, and deciding that at least one of the first material property or the third material property is the fourth material property.

In the step 518, the low-gradation image for evaluation is updated with the image that has been output in the step 517.

In the step 519, the first BH is updated with the third BH that has been output in the step 517.

Then, the flow returns to the step 508 and repeats the steps 508 to 520 for any number of times. In the present embodiment, the repetition terminates after either 10,000 times of repetition or 200 continuous no improvements of BH, whichever is earlier.

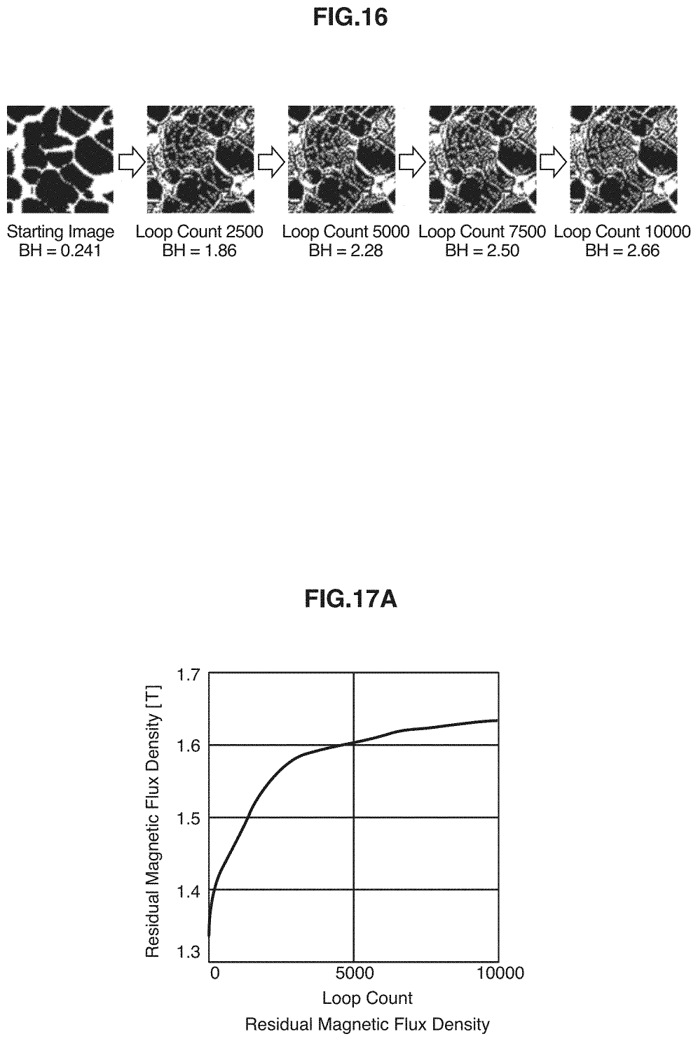

FIG. 16 shows the material structure images created in the present embodiment and BH thereof. As shown in FIG. 16, the structure images in which the predicted magnetic properties BH are higher than in the starting image can be automatically created.

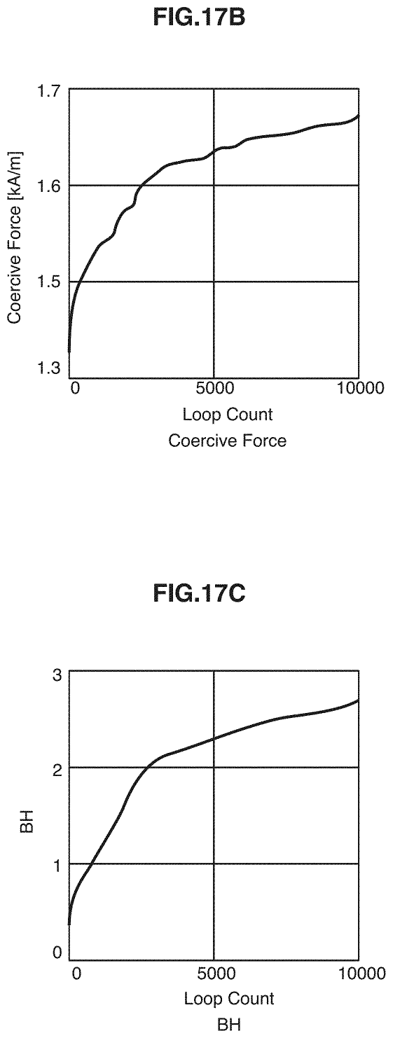

FIG. 17 shows changes in residual magnetic flux density, coercive force, and BH against a loop count at the time of creating the images shown in FIG. 16. Changing the images so as to improve BH enables to achieve a result in which residual magnetic flux density and coercive force are improved at the same time.

As described in the present embodiment above, by optimizing the images so as to improve BH of the magnetic properties while automatically creating the material structure images, it is possible to automatically create the material structure images that can improve material properties BH.

As a method for optimization, a hill-climbing method is used in the present embodiment. Other unlimited optimization methods such as an annealing method or a genetic algorithm may also be used.

As above, according to the present embodiment, the properties of material structures can be tested easily and quickly without any measurements through experiments. Furthermore, virtual images of the material structures that can improve material properties can be obtained.

In the present embodiment, the magnetic properties are predicted by using cross-sectional structure images of the magnet for learning photographed under an electron microscope. However, the photographed images are not limited to the structure images. For example, a surface of a material may be photographed and a property concerning a surface condition, such as a friction coefficient, can also be predicted.

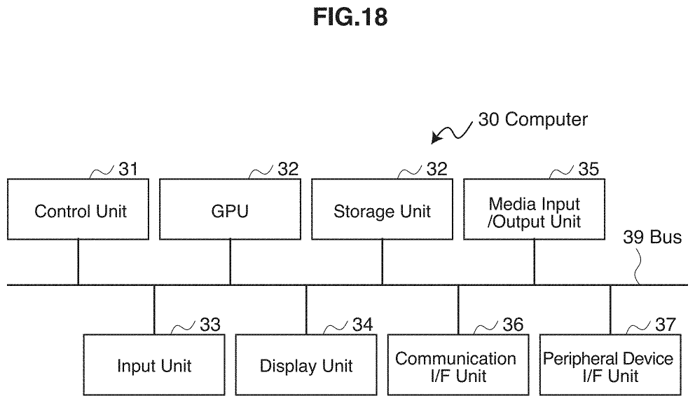

FIG. 18 is a view showing an example of a hardware configuration of a computer 30 (an apparatus for evaluating material properties) that carries out the method for evaluating material properties according to the first to fourth embodiments of the present invention.

As shown in FIG. 18, the computer 30 includes a control unit 31, a storage unit 32, an input unit 33, a display unit 34, a media input/output unit 35, a communication interface (I/F) unit 36, a peripheral device interface (I/F) unit 37, and so on that are connected to each other via a bus 39. The computer 30 may further include a graphical processing unit (GPU) 40, which is an arithmetic operation unit for image processing.

The control unit 31 is configured by a central processing unit (CPU), a read only memory (ROM), a random access memory (RAM), and the like. The control unit 31 reads out programs stored in the storage unit 32, a ROM, or a storage medium (media), etc. to a working memory area on a RAM, carries out the program, and drives and controls the devices that are connected via the bus 39. The ROM permanently holds a boot program, programs such as BIOS, and data for the computer 30. The RAM temporary holds loaded programs and data, and, at the same time, provides a working area for the control unit 31 to perform various processes.

The control unit 31 also performs the processes shown in FIGS. 2, 3, 6, 7, 8, 13, and 14 according to processing programs stored in the storage unit 32. The processing programs may be stored in the storage unit 32 or the RAM of the computer 30 in advance, or may be downloaded via networks etc. and stored in the storage unit 32 or the like.

The GPU 40 is an arithmetic operation unit for image processing. Considering arithmetic operational load in the control unit 31 (CPU), the GPU 40 may be provided in addition to the CPU so that parallel processing may be performed. The number of the GPU 40 is not limited to one, and a plurality of the GPU 40 may be provided. However, for simplification of the device configuration, only the CPU (the control unit 31) may perform the process without providing the GPU 40.

The storage unit 32 is a hard disk drive (HDD) or the like, which stores programs executed by the control unit 31, data necessary for execution of the programs, an operation system (OS), and the like. The control unit 31 reads out source codes of such programs as necessary and moves the codes to the RAM, and the CPU then reads out and executes the programs.

The input unit 33 is an input device including a keyboard, pointing devices such as a mouse, a touch panel, or a tablet, and a ten-key pad. The input unit 33 outputs input data to the control unit 31.

The display unit 34 is a display device such as a liquid crystal panel or a CRT monitor, and a logic circuit (a video adapter etc.) for carrying out display processing in association with the display device. The display unit 34 displays on the display device displaying information that is directed and input by the control unit 31.

A touch-panel input/output unit, in which the input unit 33 and the display unit 34 are integrated, may also be used.

The media input/output unit 35 is an input/output device for various storage media, such as a CD/DVD drive. The media input/output unit 35 carries out input and output of data.

The communication I/F unit 36 includes a communication control device, a communication port, and the like. The communication I/F unit 36 is an interface that mediates communications with external devices that are communicatively connected via networks, and controls the communication.

The peripheral device I/F unit 37 is a port for connecting a peripheral device to the computer 30, and the computer 30 transmits data to and receives data from the peripheral device via the peripheral device I/F unit 37. The peripheral device I/F unit 37 is configured by a USB or IEEE1394, etc.

The bus 39 is a route that mediates transactions and receptions of control signals and data signals between the devices.

Although the embodiments of the present invention have been described as above, the technical scope of the present invention is not limited to the embodiments described above. The contents can be changed within the technical scope included in the specification.

What is claimed is:

1. A method for evaluating material properties, the method comprising:
an image processing for evaluation step of scanning one or more image for evaluation of a material to be evaluated, creating a low-gradation image for evaluation by lowering gradation of the image for evaluation, and creating a virtual image by processing the low-gradation image for evaluation;
a material properties prediction step of extracting features for evaluation from the low-gradation image for evaluation, predicting a first material property of the material to be evaluated from the features for evaluation through a regression model, extracting virtual-image features from the virtual image, and predicting a second material property of the material to be evaluated from the virtual-image features through the regression model; and
an evaluation step of comparing the first material property with the second material property.

2. A method for evaluating material properties, the method comprising:
a material properties primary prediction step of scanning one or more image for evaluation of a material to be evaluated, creating a low-gradation image for evaluation by lowering gradation of the image for evaluation, extracting features for evaluation from the low-gradation image for evaluation, and predicting a first material property of the material to be evaluated from the features for evaluation through a regression model;
a virtual material properties prediction step of creating a virtual image from the low-gradation image for evaluation by changing processing conditions to the low-gradation image for evaluation, extracting virtual-image features from the virtual image, predicting material properties for each of the processing conditions from the virtual-image features through the regression model, and determining a third material property among the material properties for each of the processing conditions; and
a material search evaluation step of comparing the first material property with the third material property, and deciding that at least one of the first material property or the third material property is a fourth material property, wherein
the virtual material properties prediction step and the material search evaluation step are repeatedly carried out while replacing the fourth material property and an image used for computing the fourth material property with the first material property and the low-gradation image for evaluation, respectively.

3. The method for evaluating material properties according to claim 1, the method further comprising:
an image processing for learning step of creating low-gradation images for learning by lowering gradation of a plurality of images for learning obtained through photographing at least one material for learning to have a group of low-gradation images for learning; and
a machine learning step of loading and making correlations between the group of low-gradation images for learning and material properties of the material for learning in the group of low-gradation images for learning, extracting features for learning from the low-gradation images for learning, and learning a regression model that predicts material properties of the material for learning from the features for learning.

4. The method for evaluating material properties according to claim 2, the method further comprising:
an image processing for learning step of creating low-gradation images for learning by lowering gradation of a plurality of images for learning obtained through photographing at least one material for learning to have a group of low-gradation images for learning; and
a machine learning step of loading and making correlations between the group of low-gradation images for learning and material properties of the material for learning in the group of low-gradation images for learning, extracting features for learning from the low-gradation images for learning, and learning a regression model that predicts material properties of the material for learning from the features for learning.

5. The method for evaluating material properties according to claim 3, the method further comprising:
a feature specifying step of reducing features for learning that are required for predicting material properties of the material for learning from the low-gradation images for learning.

6. The method for evaluating material properties according to claim 4, the method further comprising:
a feature specifying step of reducing features for learning that are required for predicting material properties of the material for learning from the low-gradation images for learning.

7. An apparatus for evaluating material properties comprising:
an image processing for evaluation unit configured to scan one or more image for evaluation of a material to be evaluated, create a low-gradation image for evaluation by lowering gradation of the image for evaluation, and create a virtual image by processing the low-gradation image for evaluation;
a material properties prediction unit configured to extract features for evaluation from the low-gradation image for evaluation, predict a first material property of the material to be evaluated from the features for evaluation through a regression model, extract virtual-image features from the virtual image, and predict a second material property of the material to be evaluated from the virtual-image features through the regression model; and
an evaluation unit configured to compute the first material property with the second material property.

8. An apparatus for evaluating material properties comprising:
a material properties primary prediction unit configured to scan one or more image for evaluation of a material to be evaluated, create a low-gradation image for evaluation by lowering gradation of the image for evaluation, extract features for evaluation from the low-gradation image for evaluation, and predict a first material property of the material to be evaluated from the features for evaluation through a regression model;
a virtual material properties prediction unit configured to create a virtual image from the low-gradation image for evaluation by changing processing conditions to the low-gradation image for evaluation, extract virtual-image features from the virtual image, predict material properties for each of the processing conditions from the virtual-image features through the regression model, and determine a third material property among the material properties for each of the processing conditions; and
a material search evaluation unit configured to compare the first material property with the third material property, and decide that at least one of the first material property or the third material property is a fourth material property, wherein
processes by the virtual material properties prediction unit and processes by the material search evaluation unit are repeatedly carried out while replacing the fourth material property and an image used for computing the fourth material property with the first material property and the low-gradation image for evaluation, respectively.
